(19) United States
(12) Patent Application Publication
(10) Pub. No.: US 2011/0203467 A1
(43) Pub. Date: Aug. 25, 2011

(54) Printer

(76) Inventor: Akio Naito, Chiba-shi (JP)

(21) Appl. No.: 12/931,945

(22) Filed: Feb. 15, 2011

(30) Foreign Application Priority Data
Feb. 22, 2010 (JP) 2010-036550

(51) Int. Cl. B41F 5/00

(52) U.S. Cl. 101/212

(57) ABSTRACT

Provided is a printer in which attachment and detachment manipulation of a platen roller can easily be performed, in which the platen roller can be retained with high reliability at a time of attachment, and in which downsizing of the entire printer is achieved due to use of the platen roller smaller in diameter. A printer (1) includes: a rocking plate (22) including a bearing portion (22a) for axially supporting a platen roller (21); a rock shaft (23) inserted through a slide opening portion (26) so as to be combined with the rocking plate; and a stationary frame (40) to which a recording head (42) is fixed, in which: the rock shaft is slidingly movable in an imaginary in-plane direction orthogonal to a platen axis; the stationary frame includes a first recess (45) into which the bearing portion is disengageably fitted, and a second recess (46) into which, after the bearing portion is fitted, the rock shaft is disengageably fitted; and the bearing portion is undisengageable from inside the first recess while the rock shaft is fitted, and is disengageable from inside the first recess after the rock shaft is disengaged.

### 1. FIELD OF THE INVENTION

The present invention relates to a printer in which a platen roller and a recording head are separably combined with each other.

### 2. DESCRIPTION OF THE RELATED ART

As conventionally known printers, there are given printers in which a recording head and a platen roller held in contact with the recording head are provided inside a casing, and in which the recording head performs recording onto a recording sheet sent out by the platen roller. In the printers of this type, for example, at the time of setting of the recording sheet or jam treatment, or at the time of maintenance or replacement of the recording head, the platen roller, and the like, the recording head and the platen roller remain in contact with each other inside the casing. Thus, workability is poor.

In view of this, it is desired that the recording head and the platen roller can be spaced apart from each other so as to be exposed to an outside of the casing. In particular, the recording head includes a plurality of recording elements (heat-generating elements or the like), and hence it is preferred that the recording head be fixed on a casing side in order not to impair reliability of electrical connections into which recording signals for selectively driving the recording elements are input. In other words, it is desired that the platen roller be spaced apart from the recording head so as to be exposed to the outside, with the recording head being fixed on the casing side.

For satisfaction of the needs, there have been provided some printers in which the platen roller is freely attachable and detachable and, at the time of attachment, the platen roller is retained under a state of being held in contact with the recording head at a predetermined pressure.

As one of the printers, there has been known a printer which includes a regulating member and a stationary frame, in which a platen roller can be easily attached and detached with use of those members, and in which the platen roller can be retained with high reliability while the platen roller is prevented from being inadvertently disengaged at the time of mounting (refer to JP 4376816 B).

The regulating member includes a connecting portion into which a shaft portion of the platen roller is fitted, and the regulating member is undisengageably combined with the platen roller through intermediation of the connecting portion. Meanwhile, the regulating member is rotatably combined coaxially with and relatively to the platen roller. Note that, regarding movement except the relative rotation, the regulating member moves integrally with the platen roller. Further, the regulating member is provided with a protrusion-like engagement portion.

Meanwhile, the stationary frame is fixed to a base of a casing, and includes a first recess and a second recess. The first recess is a recess for positioning the platen roller to a recordable position by bringing the platen roller into contact with the recording head when the shaft portion of the platen roller is inserted. The second recess is a recess for retaining a protrusion of the stationary frame when the protrusion is inserted under a state in which the shaft portion of the platen roller is inserted in the first recess.

When the platen roller is attached in the printer structured as described above, the shaft portion of the platen roller is inserted in the first recess and retained therein, and then the regulating member is rotated relatively to the platen roller and the protrusion is inserted into the second recess and retained therein. With this, at the recordable position at which the platen roller is held in contact with the recording head, the platen roller can be reliably retained.

In particular, due to a positional relation, shapes, and the like of the first recess and the second recess, even with application of an external force, for example, the platen roller is prevented from being disengaged from the first recess, and the platen roller and the protrusion are prevented from being simultaneously disengaged respectively from the first recess and the second recess. In other words, the printer is designed so that the platen roller is less liable to be inadvertently disengaged. Thus, the platen roller can be retained with high reliability.

Meanwhile, when the platen roller is detached, the regulating member is rotated relatively to the platen roller (rotated in a direction reverse to that in the above-mentioned case). Consequently, the protrusion is disengaged from the second recess, and then the shaft portion of the platen roller is disengaged from the first recess. In this manner, the platen roller can be detached.

As described above, the platen roller can be attached and detached with a simple manipulation of rotating the regulating member so that the protrusion is inserted into or disengaged from the second recess. Thus, the printer is excellent in manipulation properties of attachment and detachment.

By the way, as well as for various electronic apparatuses, further downsizing of printers will be required also in the future. Thus, it is desired that the printers be structured as simply as possible and components be designed to be small. In particular, the platen roller for feeding the recording sheet is larger among the components of the printers, and hence occupies a large space in the printer. Thus, downsizing of the printer is efficiently achieved through possible reduction of a diameter of the platen roller.

In this regard, in the above-mentioned conventional printer, it is structurally difficult to reduce the diameter of the platen roller, and hence there has been a room for improvement. Specifically, the connecting portion of the regulating member is coaxially fitted into the shaft portion of the platen roller. Accordingly, when the diameter of the platen roller is reduced, it is necessary to reduce an outer diameter of the connecting portion in accordance therewith. However, in order to reliably fit the connecting portion into the shaft portion without backlash or the like, it is structurally necessary to secure a certain outer diameter. Accordingly, it is practically difficult to further reduce the diameter of the platen roller at present.

### SUMMARY OF THE INVENTION

The present invention has been made in view of such circumstances. It is therefore an object of the present invention to provide a printer in which the attachment and detachment manipulation of the platen roller can easily be performed, in which the platen roller can be retained with high reliability at the time of attachment, and in which downsizing of the entire printer is easily achieved due to use of the platen roller smaller in diameter.

The present invention provides the following measures for achieving the above-mentioned object.

(1) According to the present invention, there is provided a printer in which a recording head and a platen roller are separably combined with each other. The printer includes: a rocking plate which includes a bearing portion for axially supporting the platen roller, and is fixed to a platen frame so as to be rockable under a state of axially supporting the platen roller; a rock shaft which extends parallel to a platen axis of the platen roller, and is inserted through an elongated-hole-shaped slide opening portion formed in the rocking plate so as to be combined with the rocking plate; and a stationary frame to which the recording head is fixed, in which: the rock shaft is slidingly movable in an imaginary in-plane direction orthogonal to the platen axis; the stationary frame includes a first recess into which the bearing portion is disengageably fitted, the first recess retaining the platen roller at a position of facing the recording head, and a second recess into which, after the bearing portion is fitted into the first recess, the rock shaft is disengageably fitted due to sliding movement; and the bearing portion is undisengageable from inside the first recess while the rock shaft is fitted in the second recess, and is disengageable from inside the first recess after the rock shaft is disengaged from inside the second recess.

According to the printer of the present invention, the attachment and detachment manipulation of the platen roller can easily be performed, and hence the platen roller and the recording head can be quickly combined with each other or quickly separated and disengaged from each other.

First, when the platen roller is attached, the bearing portion provided to the rocking plate for the purpose of axially supporting the platen roller is inserted and fitted into the first recess of the stationary frame. In this case, the rocking plate is fixed to the platen frame so as to be rockable, and hence the bearing portion can be smoothly fitted into the first recess. As a result of fitting of the bearing portion into the first recess, the platen roller can be retained at the position of facing the recording head, and a printable state can be achieved.

Next, the rock shaft inserted through the slide opening portion so as to be combined with the rocking plate is slidingly moved, and is inserted and fitted into the second recess of the stationary frame. With this, the attachment of the platen roller is completed, and the bearing portion is undisengageable from inside the first recess.

In particular, even when an external force is applied to the platen roller from the recording head, the recording sheet, and the like, the bearing portion is prevented from being disengaged from inside the first recess. Thus, the platen roller can be retained with high reliability at the time of attachment. Note that, the rock shaft is less liable to be disengaged from the second recess unless it is intentionally slidingly moved. Accordingly, also in this regard, the platen roller can be retained with high reliability.

Meanwhile, when the platen roller is separated from the recording head, the rock shaft is slidingly moved in a direction reverse to that in the above-mentioned case so that the rock shaft is disengaged from the second recess. Next, the bearing portion is disengaged from the first recess. With this, the platen roller can be separated from the recording head.

In this manner, the attachment and detachment manipulation of the platen roller can easily be performed with such a simple manipulation that the bearing portion is fitted into or disengaged from inside the first recess and that the rock shaft is fitted into or disengaged from inside the second recess due to sliding movement manipulation. Accordingly, as described above, the platen roller and the recording head can be quickly combined with each other or quickly separated and disengaged from each other.

Further, the rock shaft is inserted through the slide opening portion regardless of presence of the platen roller so as to be combined with the rocking plate. Thus, unlike conventional printers (in which the rotary axis of the latch member is coaxial with the platen axis), even when being individually and freely designed, the platen roller and the rock shaft are less liable to have influence on each other. Accordingly, a degree of freedom in designing of the platen roller and the rock shaft can be enhanced. In addition, a shape of the platen roller is less liable to have influence on strength or movement of the rock shaft, and hence the platen roller can be reduced in diameter. Accordingly, the printer can be easily downsized as a whole.

(2) According to the printer of the present invention, the rock shaft is slidingly movable along the slide opening portion.

(3) According to the printer of the present invention, the printer further includes an urging member provided between the platen frame and the rock shaft, for urging the rock shaft so as to slidingly move the rock shaft in a direction of being fitted into the second recess.

According to the printer of the present invention, the rock shaft is urged by the urging member, and hence can be smoothly fitted into the second recess in a shorter period of time than that of fitting the rock shaft in after the bearing portion is fitted into the first recess. Accordingly, the platen roller can be more efficiently attached. Further, after the platen roller is attached, the rock shaft is in a state of being less liable to move in a direction of being disengaged from inside the second recess by an urging force of the urging member. Accordingly, the platen roller can be retained with higher reliability at the time of attachment.

(4) According to the printer of the present invention, the printer further includes: a base member for accommodating a sheet roll formed of a wound recording sheet to be fed between the recording head and the platen roller; and a lid member openably and closably coupled to the base member, in which: the stationary frame is fixed to the base member; and the platen frame is fixed to the lid member.

According to the printer of the present invention, the lid member can be opened and closed in conjunction with the attachment and detachment manipulation of the platen roller, and hence the printer is easy to use. In addition, the recording sheet drawn out from the sheet roll can be easily set between the platen roller and the recording head.

Further, the locking and unlocking of the lid member is performed simultaneously with the attachment and detachment of the platen roller. Thus, it is unnecessary to provide a member dedicated for the locking and unlocking of the lid member, and hence the structure of the printer can be simplified.

(5) According to the printer of the present invention, the lid member includes a manipulation lever for slidingly moving the rock shaft.

According to the printer of the present invention, the rock shaft can be slidingly moved through intermediation of the manipulation lever, and hence the attachment and detachment manipulation of the platen roller can be more easily performed. In particular, the manipulation lever is provided on the lid member, and hence the lid member can be opened and closed with a series of manipulations simultaneously with the manipulation of the manipulation lever, which leads to enhancement of manipulation properties.

According to the printer of the present invention, the attachment and detachment manipulation of the platen roller can easily be performed, and the platen roller can be retained with high reliability at the time of attachment. Further, reduction of a diameter of the platen roller can be achieved, and downsizing of the entire printer is easily achieved.

### BRIEF DESCRIPTION OF THE DRAWINGS

In the accompanying drawings:

FIG. 1 is a side view of a printer according to an embodiment of the present invention, illustrating a state in which a platen unit and a main unit are combined with each other;

FIG. 2 is a side view illustrating a state in which the platen unit and the main unit in the state illustrated in FIG. 1 are disengaged from each other and a lid member is widely opened;

FIG. 3 is a front view of the platen unit in a state of being fixed to an inner surface of the lid member illustrated in FIG. 2;

FIG. 4 is a side view of the platen unit and the lid member, seen from a direction of the arrow A illustrated in FIG. 3;

FIG. 5 is an outer appearance perspective view of the platen unit, seen from a platen frame side;

FIG. 6 is a partially sectional perspective view of the platen unit taken along the line B-B illustrated in FIG. 5;

FIG. 7 is a side view of the main unit, seen from a direction of the arrow C illustrated in FIG. 2;

FIG. 8 is an enlarged view of a vicinity of a rocking plate in the state illustrated in FIG. 1, illustrating a state in which a bearing portion is fitted in a first recess and a rock shaft is fitted in a second recess;

FIG. 9 illustrates a state in which the rock shaft in the state illustrated in FIG. 8 has slidingly moved and got out from inside the second recess;

FIG. 10 illustrates a state in which the bearing portion in the state illustrated in FIG. 9 has started to be disengaged from inside the first recess;

FIG. 11 is a side view of a modification of the platen unit according to the present invention; and

FIG. 12 illustrates a state in which, in the platen unit illustrated in FIG. 11, the bearing portion has started to be disengaged from inside the first recess simultaneously with the rock shaft getting out from the second recess.

### DETAILED DESCRIPTION OF THE PREFERRED EMBODIMENT

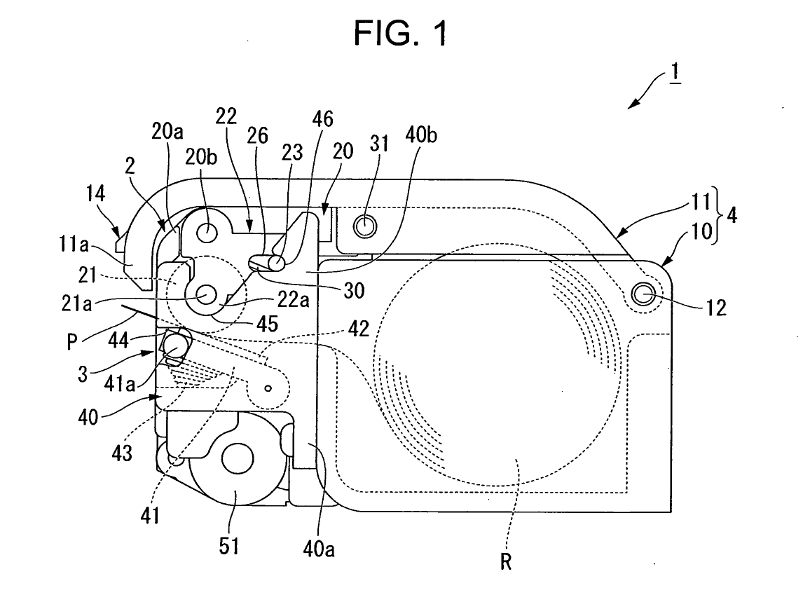

In the following, description is made of an embodiment according to the present invention with reference to FIGS. 1 to 12. Note that, in this embodiment, description is made of a thermal printer as an example of a printer.

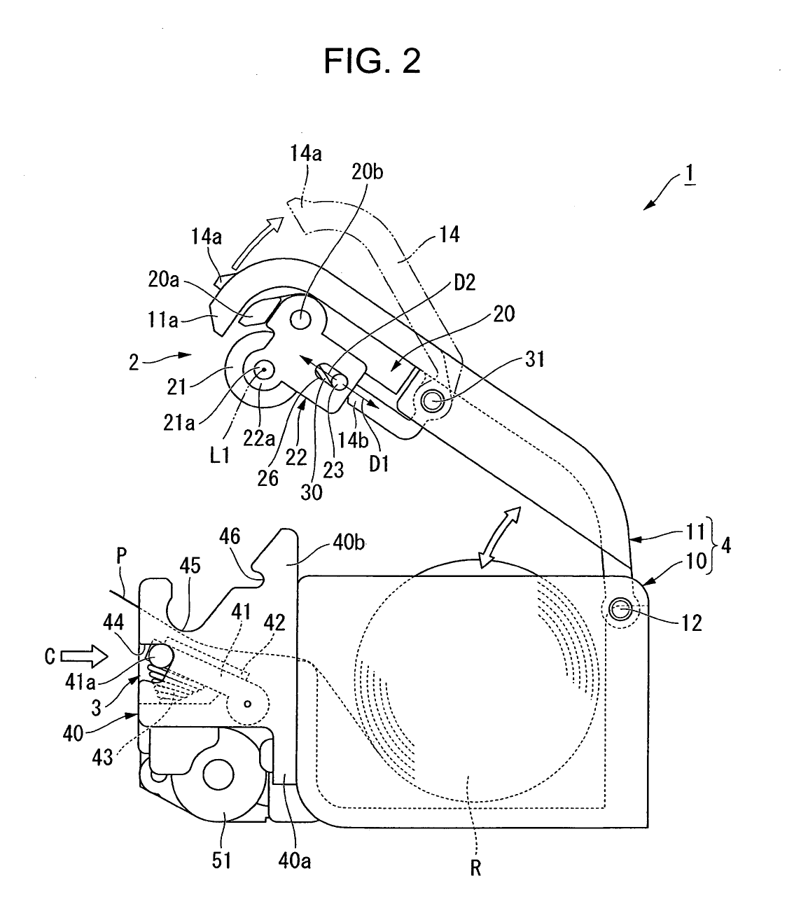

As illustrated in FIGS. 1 and 2, a printer 1 according to this embodiment includes a platen unit 2 and a main unit 3 which are separably combined with each other and a casing 4 for accommodating a sheet roll R formed of a wound recording sheet P.

Note that, FIG. 1 is an overall side view of the printer 1 in a state in which the platen unit 2 and the main unit 3 are combined with each other. FIG. 2 is an overall side view illustrating a state in which the platen unit 2 and the main unit 3 in the state illustrated in FIG. 1 have been separated from each other.

First, description is made of the casing 4.

The casing 4 according to this embodiment includes a base member 10 and a lid member 11 openably and closably (rotatably) coupled to the base member 10 through intermediation of a rotary shaft 12.

The base member 10 is made of a resin material or the like in a box shape and an upper side thereof is open so that the sheet roll R is accommodated therein. The lid member 11 is made of a resin material as well as the base member 10, and functions to expose an opening of the base member 10 in an opened state and cover the opening of the base member 10 in a closed state.

Note that, locking and unlocking of the lid member 11 is effected by attachment and detachment of the platen unit 2 and the main unit 3.

Further, the lid member 11 is formed to extend outward beyond the base member 10 (to the left side of the drawing sheets of FIGS. 1 and 2), and the platen unit 2 is fixed to an inner surface of the extended part. Note that, a distal end portion 11a of the lid member 11 extending outward beyond the base member 10 is curved downward, and covers a part of the platen unit 2 from the outside. Further, a manipulation lever 14 is rotatably coupled to a surface side of the lid member 11 through intermediation of the rotary shaft 12. Description of the manipulation lever 14 is made later.

Next, description is made of the platen unit 2.

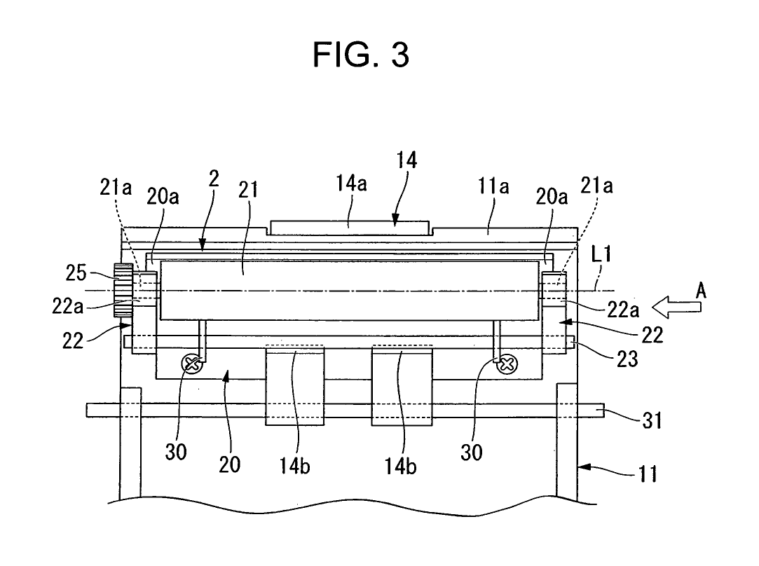

As illustrated in FIGS. 3 to 5, the platen unit 2 includes: a platen frame 20 fixed to the inner surface of the lid member 11; a platen roller 21 for feeding the recording sheet P; rocking plates 22 each including a bearing portion 22a for axially supporting the platen roller 21, the rocking plates 22 being fixed to the platen frame 20 so as to be rockable under a state of axially supporting the platen roller 21; a rock shaft 23 combined with the rocking plates 22 through intermediation of slide opening portions 26; and a driven gear 25.

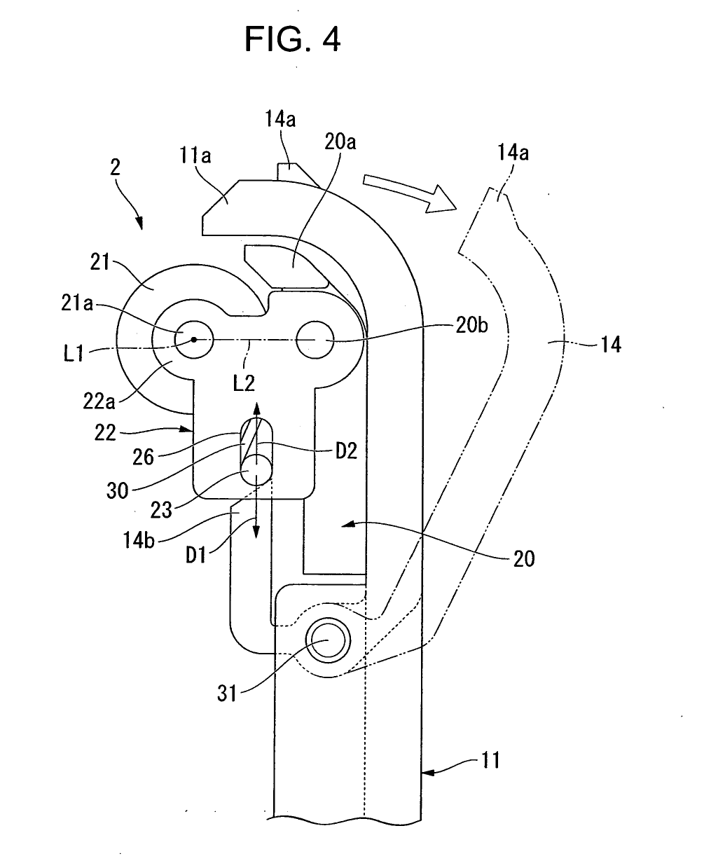

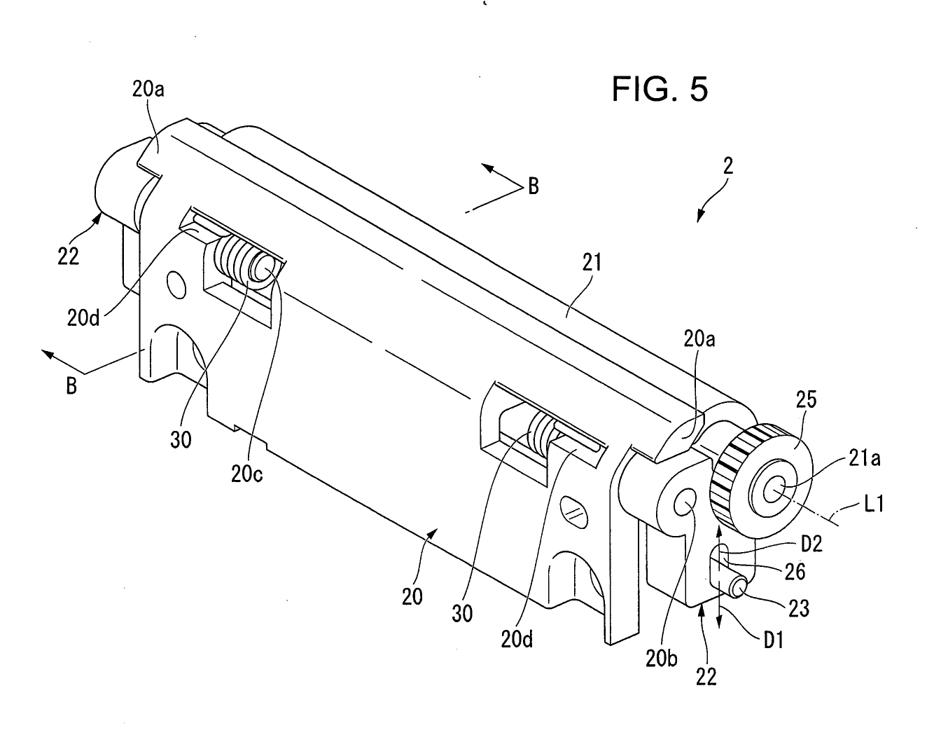

Note that, FIG. 3 is a front view of the platen unit 2 in a state of being fixed to the inner surface of the lid member 11. FIG. 4 is a side view of the platen unit 2 and the lid member 11, seen from a direction of the arrow A illustrated in FIG. 3. FIG. 5 is an outer appearance perspective view of the platen unit 2, seen from the platen frame 20 side.

As illustrated in FIG. 3, the platen frame 20 is formed to have a lateral width slightly narrower than a lateral width of the lid member 11 and formed in a substantially plate-like shape. The platen frame 20 is fixed so as to overlap the most part of the inner surface of the lid member 11 with fastening means such as a screw.

On each side on one end side (distal end portion 11a side of the lid member 11) of the platen frame 20, there is formed a stopper claw 20a protruding in a direction parallel to a platen axis of the platen roller 21.

The platen roller 21 is a roller which includes a shaft 21a covered with an elastic material such as rubber, and extends along a platen shaft L1, and the plate roller 21 has both end portions from which a shaft 21a projects. As described above, the platen roller 21 is axially supported by the rocking plates 22.

The rocking plates 22 are plates each formed in a substantially T-shape in side view and are arranged in a manner of sandwiching the platen roller 21. A root side of each of the rocking plates 22 is rotatably coupled to a coupling pin 20b projecting in the direction parallel to the platen axis L1 from corresponding one side of the platen frame 20. With this, the rocking plates 22 are rockable about the coupling pins 20b.

The bearing portions 22a are formed on distal end sides of the rocking plates 22, and axially support the shaft 21a projecting from both the end portions of the platen roller 21. With this, the platen roller 21 is axially supported by the rocking plates 22 and coupled to the platen frame 20 through intermediation of the rocking plates 22.

Note that, the driven gear 25 is fixed on one side of the shaft 21a with one of the rocking plates 22 being interposed therebetween. The driven gear 25 is rotated by a rotational force transmitted thereto when the platen unit 2 and the main unit 3 are combined with each other and the driven gear 25 meshes with a platen gear train 50 described later. With this, the platen roller 21 is capable of being rotated about the platen axis L1 in accordance with rotation of the driven gear 25 so as to feed the recording sheet P drawn out from the sheet roll R.

Incidentally, the slide opening portion 26 is formed in a plane of each of the rocking plates 22. The slide opening portion 26 is provided as an opening portion formed in an elongated hole shape along a direction substantially orthogonal to an imaginary straight line L2 (refer to FIG. 4) connecting the platen axis L1 and a center of the coupling pin 20b to each other.

The rock shaft 23 is inserted through the slide opening portion 26. With this, the rock shaft 23 is engaged with the rocking plate 22. The rock shaft 23 is a shaft extending parallel to the platen axis L1, and is inserted through the slide opening portion 26 in a state of being positioned on the rotary shaft 12 side relative to the platen roller 21. Further, the rock shaft 23 is formed to have a length sufficient for each end portion thereof to project to an outside of corresponding one of the rocking plates 22.

Further, the rock shaft 23 according to this embodiment is slidingly movable in an imaginary in-plane direction orthogonal to the platen axis L1, specifically, along the slide opening portion 26. That is, the rock shaft 23 is slidingly movable along the direction orthogonal to the imaginary straight line L2 connecting the platen axis L1 and the center of the coupling pin 20b to each other.

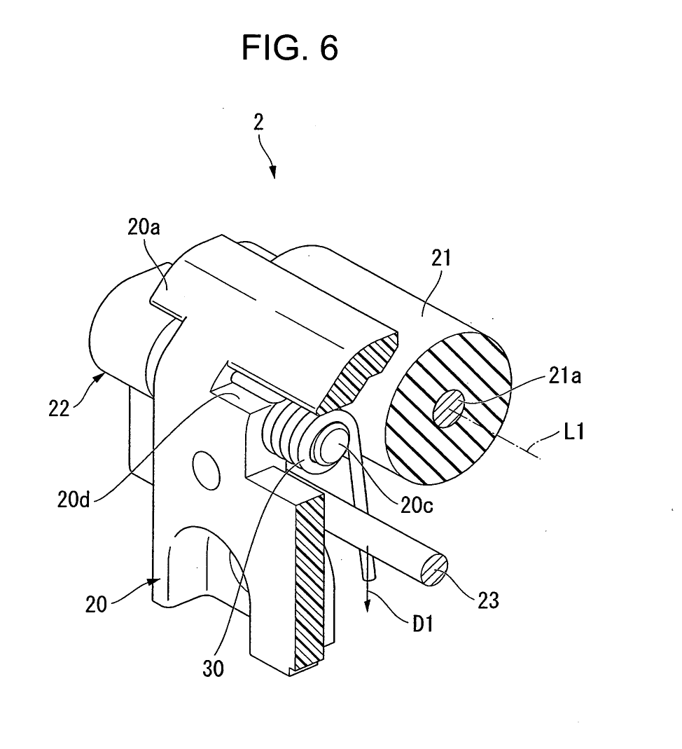

As illustrated in FIGS. 5 and 6, the rock shaft 23 combined with the rocking plates 22 as described above is urged by torsional springs (urging members) 30 so as to be slid in a direction in which the rock shaft 23 comes close to an inside of corresponding one of second recesses 46 described later, that is, in a direction of being spaced apart from the platen roller 21 (hereinafter, referred to as locking direction D1). Note that, FIG. 6 is a partially sectional perspective view of the platen unit 2 taken along the line B-B illustrated in FIG. 5.

Each of the torsional springs 30 is arranged between the platen frame 20 and the rock shaft 23. Specifically, each of the torsional springs 30 is fitted in a covering manner to a supporting pin 20c formed on the platen frame 20 side, and has one end side fitted into a groove portion 20d formed on a root side of the supporting pin 20c and another end side held in direct contact with the rock shaft 23 so as to urge the rock shaft 23 toward the rotary shaft 12. With this, the rock shaft 23 is maintained under a state of being urged to the above-mentioned locking direction D1 in the slide opening portions 26.

Further, as illustrated in FIGS. 2 and 4, with the manipulation lever 14 rotatably coupled to a surface of the lid member 11, the rock shaft 23 is slid in a direction in which the rock shaft 23 is disengaged from inside corresponding one of the second recesses 46 described later, that is, in the direction of coming close to the platen roller 21 (hereinafter, referred to as release direction D2).

In other words, the manipulation lever 14 according to this embodiment functions as an open lever for disengaging the platen unit 2 and the main unit 3 from each other and achieving an opened state of the lid member 11.

In detail, the manipulation lever 14 is formed in a J-shape in side view, and includes a manipulation end 14a formed on a distal end side thereof positioned on the distal end portion 11a side of the lid member 11. Meanwhile, a proximal end side of the manipulation lever 14 is coupled to the lid member 11 through intermediation of the rotary shaft 31, and claw portions 14b extend, on an inner surface side of the lid member 11, from the coupled portion to the rock shaft 23. The distal ends of the claw portions 14b are held in contact with the rock shaft 23 (refer to FIG. 3). In this case, the distal end of each of the claw portions 14b is obliquely cut so that the rock shaft 23 can be linearly moved along the slide opening portion 26 when the manipulation lever 14 is rotated about the rotary shaft 31.

Thus, when the manipulation lever 14 is subjected to a pulling-up manipulation (opening manipulation) through intermediation of the manipulation end 14a, the manipulation lever 14 is rotated about the rotary shaft 31 so that the claw portions 14b are capable of slidingly move the rock shaft 23 with a force resisting the torsional springs 30. In other words, the rock shaft 23 is slidingly moved to the release direction D2 of coming close to the platen roller 21.

Note that, the rocking plate 22 comes into contact with the stopper claw 20a formed on the platen frame 20 side so as to be regulated in rocking amount. Thus, the platen roller 21 is designed so as not to excessively move to the distal end portion 11a side of the lid member 11 prior to combination of the platen unit 2 and the main unit 3.

Next, description is made of the main unit 3.

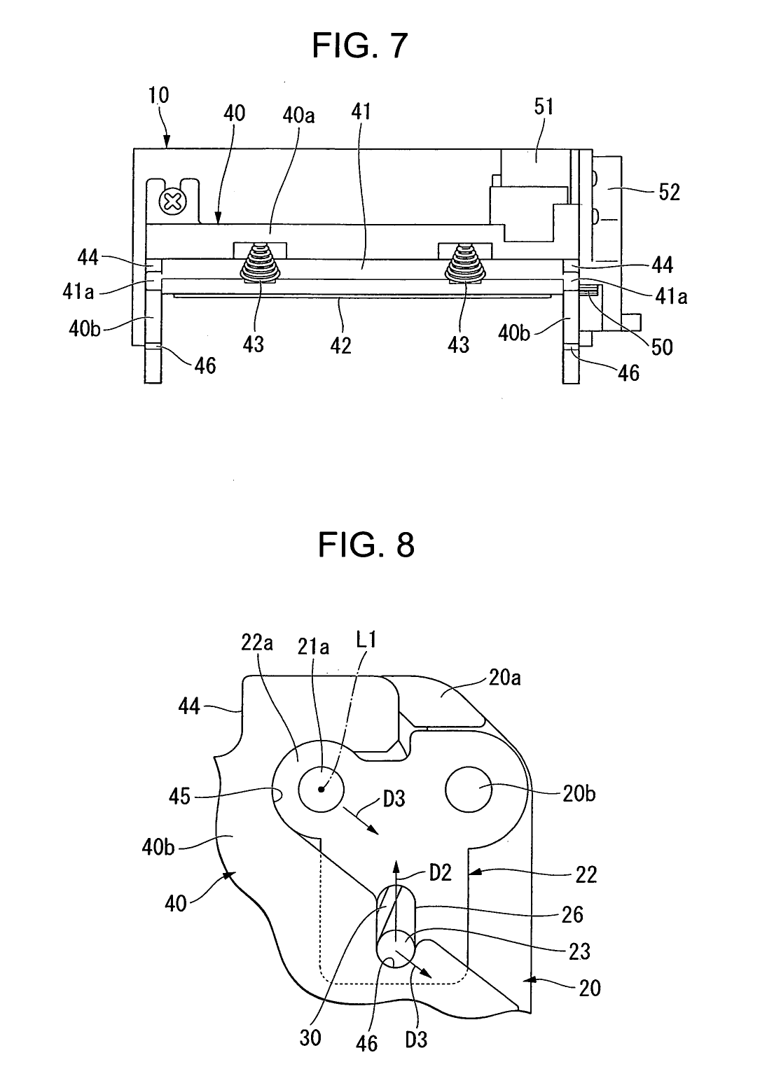

As illustrated in FIGS. 1, 2, and 7, the main unit 3 includes a stationary frame 40 fixed to the base member 10 and a thermal head (recording head) 42 fixed to the stationary frame 40 through intermediation of a head support body 41, and is arranged so as to face the platen unit 2. Note that, FIG. 7 is a side view of the main unit 3, seen from a direction of the arrow C illustrated in FIG. 2.

The stationary frame 40 is formed in a C-shape in plan view of a frame body portion 40a and facing wall portions 40b provided continuously with both sides of the frame body portion 40a so as to face each other, and is fixed to the base member 10 with the fastening means such as a screw.

The thermal head 42 includes many heat-generating elements (not shown) aligned parallel to the platen axis L1, and is secured to a front surface of the head support body 41. A flexible substrate (not shown) is connected to the thermal head 42 so that drive signals for selectively driving the heat-generating elements are input.

The head support body 41 is rockably fixed to the stationary frame 40. Between the head support body 41 and the frame body portion 40a, there are provided coil springs 43 for bringing, by urging the head support body 41, the thermal head 42 into pressure-contact with the platen roller 21 when the platen unit 2 and the main unit 3 are combined with each other. With this, at the time of printing, sheet feeding can be performed while printing is reliably performed on the recording sheet P.

Note that, a regulating pin 41a is formed at each end of the head support body 41, and intrudes into corresponding one of groove portions 44 formed on the stationary frame 40 side. Thus, the head support body 41 is regulated in rocking amount so as not to excessively rock.

The bearing portion 22a of each of the rocking plates 22 is disengageably fitted into corresponding one of the facing wall portions 40b of the stationary frame 40. The facing wall portions 40b each include a first recess 45 for retaining the platen roller 21 at a position of facing the thermal head 42, and the second recess 46 into which, after the bearing portion 22a is fitted into the first recess 45, the rock shaft 23 is fitted due to the slide movement.

In particular, the bearing portion 22a of each of the rocking plates 22 is disengageable from inside the first recess 45 while the rock shaft 23 is fitted in the second recess 46, and is undisengageable from inside the first recess 45 after the rock shaft 23 is disengaged from inside the second recess 46.

Detailed description is made of the first recess 45 and the second recess 46.

First, as illustrated in FIG. 8, the first recess 45 is formed so that an inner periphery thereof partially hinders the rocking plate 22 from being rotated about the coupling pin 20b while the bearing portion 22a and the rock shaft 23 are respectively fitted in the first recess 45 and the second recess 46. With this, under a state in which the rock shaft 23 is fitted in the second recess 46, it is impossible for the bearing portion 22a to be disengaged from inside the first recess 45.

Note that, FIG. 8 is an enlarged view of a vicinity of one of the rocking plates 22 in the state illustrated in FIG. 1, illustrating a state in which the bearing portion 22a is fitted in the first recess 45 and the rock shaft 23 is fitted in the second recess 46.

Further, as described above, the bearing portion 22a is hindered from rocking owing to interference of the inner periphery of the first recess 45. Thus, in order for the bearing portion 22a to be disengaged from inside the first recess 45 under the state in which the rock shaft 23 is fitted in the second recess 46, the bearing portion 22a is required to be moved in a direction of an arrow D3, that is, an opening direction of the first recess 45. However, the second recess 46 is formed so that an inner periphery thereof partially hinders the rock shaft 23 from being moved in the direction of the arrow D3.

Accordingly, unless the inner periphery of the second recess 46 allows the rock shaft 23 to move in the direction of the arrow D3, the bearing portion 22a is not allowed to move in the direction of the arrow D3 either. Therefore, it is impossible for the bearing portion 22a and the rock shaft 23 to be simultaneously disengaged from the first recess 45 and the second recess 46, respectively.

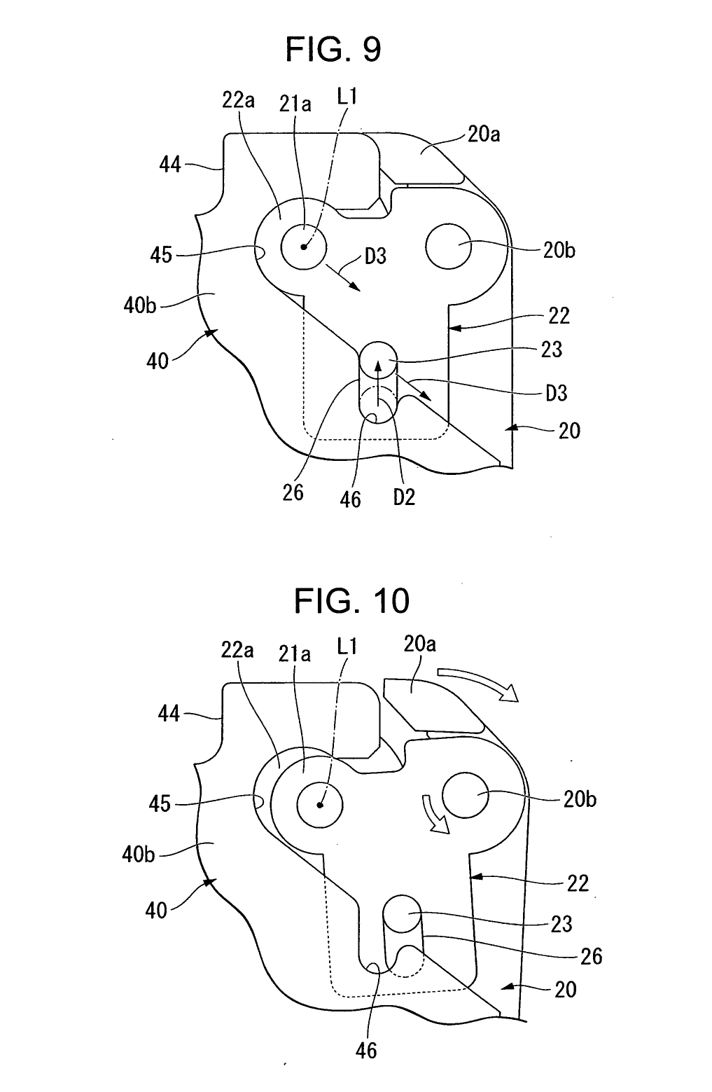

However, the second recess 46 is provided with an opening so as to allow the rock shaft 23 to slide in the release direction D2. Accordingly, as illustrated in FIG. 9, by sliding of the rock shaft 23 in the release direction D2, the rock shaft 23 can be easily disengaged from inside the second recess 46. After the rock shaft 23 is disengaged from inside the second recess 46, the bearing portion 22a can be easily disengaged from inside the first recess 45.

In this manner, only in order of disengaging first the rock shaft 23 from inside the second recess 46 and then disengaging the bearing portion 22a from inside the first recess 45, the platen roller 21 can be separated from the stationary frame 40, that is, the platen unit 2 and the main unit 3 can be separated from each other.

Further, as illustrated in FIG. 7, on the stationary frame 40 according to this embodiment, the platen gear train 50 to mesh with the driven gear 25 is arranged on an outside of one of the facing wall portions 40b. The platen gear train 50 is rotated by driving of a platen drive motor 51 fixed on a back surface side of the stationary frame 40, and functions to transmit a rotational force to the driven gear 25. Note that, the platen gear train 50 is protected by a gear cover 52.

Next, description is made of work of the printer 1 structured as described above.

First, description is made on the premise that, as illustrated in FIG. 1, the sheet roll R is accommodated in the base member 10 and the platen unit 2 and the main unit 3 are combined with each other under a state in which the recording sheet P is drawn to the outside. In this case, the lid member 11 is in the closed state of closing the opening of the base member 10 and is locked by the combination of the platen unit 2 and the main unit 3. Thus, unless the platen unit 2 and the main unit 3 are separated from each other, the lid member 11 does not enter the opened state. Further, the recording sheet P is in a state of being sandwiched between the platen roller 21 and the thermal head 42 pressed onto the platen roller 21.

In order to perform printing of various pieces of information onto the recording sheet P, the thermal head 42 is activated simultaneously with driving of the platen drive motor 51.

First, when the platen drive motor 51 is driven, a rotational force generated thereby is transmitted to the driven gear 25 through intermediation of the platen gear train 50, and hence the platen roller 21 is rotated. With this, the recording sheet P sandwiched between the platen roller 21 and the thermal head 42 is fed. Meanwhile, the many heat-generating elements appropriately generate heat due to activation of the thermal head 42. With this, various characters, graphic symbols, and the like can be clearly printed onto the recording sheet P which has been fed.

In particular, under the state in which the platen unit 2 and the main unit 3 are combined with each other, as illustrated in FIG. 8, the bearing portion 22a of the rocking plate 22 is fitted in the first recess 45 and the rock shaft 23 is fitted in the second recess 46. Thus, even when an external force is transmitted to the platen roller 21 from the thermal head 42, the recording sheet P, and the like during printing, the bearing portion 22a is prevented from being disengaged from inside the first recess 45. Thus, the platen roller 21 can be retained with high reliability. As a result, the recording sheet P can be accurately fed, and in addition, printing can be performed without involving thin spots, blurs, or the like.

Note that, even when being exposed to an external force from the platen roller 21, the recording sheet P, and the like during printing, the rock shaft 23 is less liable to be disengaged from inside the second recess 46 by inadvertent slide movement. Accordingly, also in this regard, the platen roller 21 can be retained with high reliability.

In particular, the rock shaft 23 is not in a state of being liable to be moved in the release direction D2 in which the rock shaft 23 is disengaged from inside the second recess 46 by an urging force of the torsional spring 30. Accordingly, the rock shaft 23 is less liable to be disengaged from inside the second recess 46 during printing. Also in this regard, the platen roller 21 can be reliably retained.

Next, description is made of a case where the platen unit 2 and the main unit 3 are disengaged from each other so that the platen roller 21 is separated from the thermal head 42.

In this case, first, the manipulation end 14a of the manipulation lever 14 is pulled up so that the manipulation lever 14 is rotated about the rotary shaft 31. Then, the claw portions 14b of the manipulation lever 14 press the rock shaft 23 to the platen roller 21 side with a force resisting the torsional springs 30. Thus, the rock shaft 23 is slid along the slide opening portion 26 in the release direction D2 as illustrated in FIG. 9, and is disengaged from inside each of the second recesses 46.

With this, both the bearing portion 22a and the rock shaft 23 enter a movable state in the direction of the arrow D3, that is, the opening direction of the first recess 45. In other words, the lid member 11 enters an unlocked state.

Through rotating the lid member 11 about the rotary shaft 12, simultaneously with pulling-up of the manipulation lever 14, so as to effect opening movement, both the bearing portion 22a and the rock shaft 23 move in the direction of the arrow D3, that is, the opening direction of the first recess 45. As a result, as illustrated in FIG. 10, the bearing portion 22a starts to be gradually disengaged from inside the first recess 45. In this case, the rocking plate 22 appropriately rocks. Thus, the bearing portion 22a and the rock shaft 23 smoothly move in the direction of the arrow D3 without being caught.

After that, by further proceeding of the opening movement of the lid member 11 so that the bearing portion 22a is completely disengaged from inside the first recess 45, the platen unit 2 and the main unit 3 can be separated from each other. As a result, the platen roller 21 can be detached from the thermal head 42. After that, by wide opening of the lid member 11 as illustrated in FIG. 2, replacement of the sheet roll R, various maintenance operations, and the like can be performed.

Next, description is made of a case where the platen unit 2 and the main unit 3 are combined with each other after the platen roller 21 is mounted. In this case, basically, a process reverse to the above-mentioned process is performed.

First, as illustrated in FIG. 2, under a state in which the lid member 11 is widely opened, the recording sheet P is pulled out by a certain length in advance. After that, the lid member 11 is closed, and the bearing portion 22a is fitted into the first recess 45. In this case, the rocking plate 22 appropriately rocks about the coupling pin 20b, and hence the bearing portion 22a can be smoothly fitted into the first recess 45. Then, when the lid member 11 is still further closed from this state, as illustrated in FIG. 8, the rock shaft 23 is automatically inserted and fitted into the second recess 46. In other words, the rock shaft 23 is urged by the torsional springs 30, and hence, when reaching an opening of the second recess 46, the rock shaft 23 is automatically fitted into the second recess 46.

With this, mounting of the platen roller 21 is completed and a printable state can be achieved. Simultaneously, the bearing portion 22a can be set to be undisengageable from inside the first recess 45. Further, the lid member 11 can be locked in the closed state. In other words, the state illustrated in FIG. 1 can be achieved.

As described above, according to the printer 1 of this embodiment, the attachment and detachment manipulation of the platen roller 21 can easily be performed with such a simple manipulation that the bearing portion 22a is fitted into or disengaged from inside the first recess 45, and that the rock shaft 23 is fitted into or disengaged from inside the second recess 46 due to sliding movement. Accordingly, the platen roller 21 and the thermal head 42 (platen unit 2 and the main unit 3) can be quickly combined with or quickly separated and disengaged from each other.

In addition, the rock shaft 23 is urged by the torsional springs 30, and hence the rock shaft 23 can be smoothly fitted into the second recess 46 in a short period of time after the bearing portion 22a is fitted into the first recess 45. Accordingly, the platen roller 21 can be more efficiently attached.

Further, when the platen roller 21 is attached after the platen unit 2 and the main unit 3 are combined with each other, unless the rock shaft 23 is intentionally disengaged from inside the second recess 46, the bearing portion 22a is not disengaged from inside the first recess 45. Thus, the platen roller 21 can be retained with high reliability. Accordingly, feeding of and printing onto the recording sheet P can be reliably performed, and hence reliability of the printer 1 can be enhanced.

Further, the rock shaft 23 is inserted through the slide opening portion 26 regardless of presence of the platen roller 21 so as to be combined with the rocking plate 22. Thus, unlike conventional printers (in which the rotary axis of the latch member is coaxial with the platen axis), even when being individually and freely designed, the platen roller 21 and the rock shaft 23 are less liable to have influence on the counterpart. Accordingly, a degree of freedom in design can be enhanced.

In particular, a size, a shape, and the like of the platen roller 21 are less liable to have influence on strength or movement of the rock shaft 23, and hence the platen roller 21 can be reduced in diameter. Accordingly, the printer can be easily downsized as a whole.

Further, the lid member 11 can be opened and closed in conjunction with the attachment and detachment manipulation of the platen roller 21, and hence the printer 1 is easy to use. In addition, the recording sheet P drawn out from the sheet roll R can be easily set between the platen roller 21 and the thermal head 42. Further, the locking and unlocking of the lid member 11 is performed simultaneously with the attachment and detachment of the platen roller 21. Thus, it is unnecessary to provide a member dedicated for the locking and unlocking of the lid member 11, and hence the structure of the printer 1 can be simplified.

Still further, the rock shaft 23 can be rotated through intermediation of the manipulation lever 14, and hence the attachment and detachment manipulation of the platen roller 21 can be more easily performed. In particular, the manipulation lever 14 is provided on the lid member 11, and hence the lid member 11 can be opened and closed with a series of manipulations simultaneously with the manipulation of the manipulation lever 14, which leads to enhancement of manipulation properties.

Note that, the technical scope of the present invention is not limited to the above description in this embodiment, and various modifications can be made thereto without departing from the spirit of the present invention.

For example, as described above in this embodiment, the casing 4 including the base member 10 and the lid member 11 is not essential, and hence is not required to be provided. That is, functions as a printer can be sufficiently exerted only with the main unit 3 and the platen unit 2.

Further, as described above in this embodiment, although the slide opening portions 26 are formed in the direction orthogonal to the imaginary straight line L2 connecting the platen axis L1 and the center of each of the coupling pins 20b to each other, this should not be construed restrictively. The slide opening portions 26 may be formed in a direction crossing the imaginary straight line L2.

Further, as described above in this embodiment, although the rock shaft 23 is slidingly movable along the slide opening portions 26, this should not be construed restrictively. It is only necessary that the rock shaft 23 be slidable in the imaginary in-plane direction orthogonal to the platen axis L1.

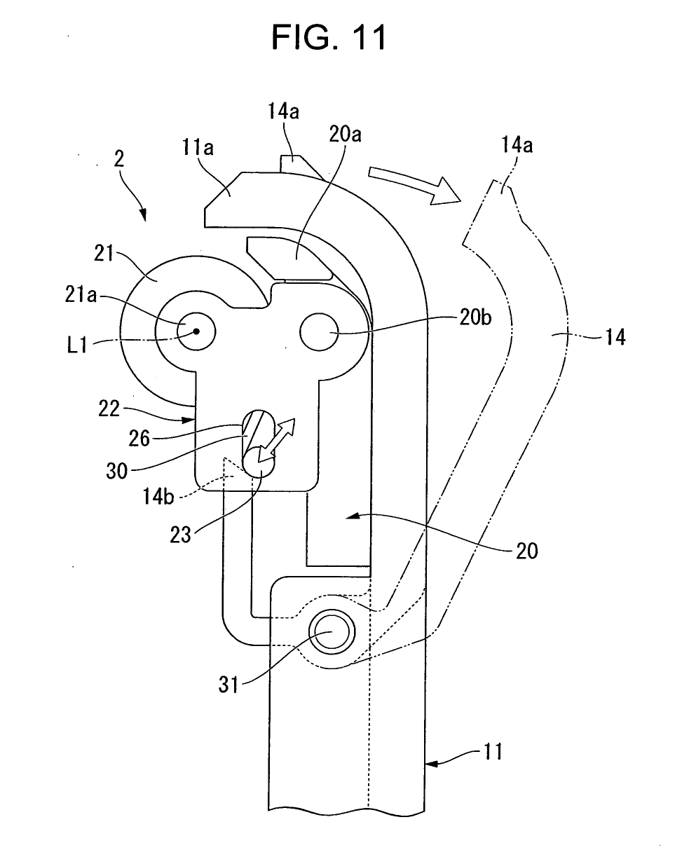

For example, as illustrated in FIG. 11, the rock shaft 23 may be retained by the platen frame 20 in a manner of being slidingly movable so that the rocking plates 22 are rockable about the coupling pins 20b. Note that, in this case, it is only necessary that shapes of the claw potions 14b of the manipulation lever 14 be appropriately changed in accordance with a sliding direction of the rock shaft 23.

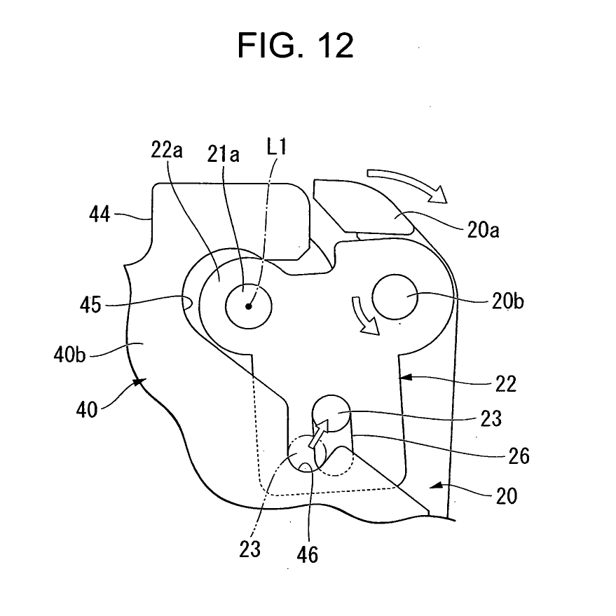

In such configuration, as illustrated in FIG. 12, when the rock shaft 23 is disengaged from inside the second recesses 46 by the sliding movement, the rocking plates 22 can be made to rock simultaneously therewith. In this case, the slide opening portions 26 also rock, and hence the rock shaft 23 enters a state of having moved relatively in the slide opening portions 26. In particular, in this case, movement of disengaging the rock shaft 23 from inside the second recesses 46 and rocking movement of the rocking plates 22 can be simultaneously effected. Thus, an advantage of more easily disengaging the bearing portions 22a from inside the first recesses 45 can be expected.

What is claimed is:

1. A printer in which a recording head and a platen roller are separably combined with each other, comprising:
a rocking plate which comprises a bearing portion for axially supporting the platen roller, and is fixed to a platen frame so as to be rockable under a state of axially supporting the platen roller;
a rock shaft which extends parallel to a platen axis of the platen roller, and is inserted through an elongated-hole-shaped slide opening portion formed in the rocking plate so as to be combined with the rocking plate; and
a stationary frame to which the recording head is fixed, wherein:
the rock shaft is slidingly movable in an imaginary in-plane direction orthogonal to the platen axis;
the stationary frame comprises
a first recess into which the bearing portion is disengageably fitted, the first recess retaining the platen roller at a position of facing the recording head, and
a second recess into which, after the bearing portion is fitted into the first recess, the rock shaft is disengageably fitted due to sliding movement; and
the bearing portion is undisengageable from inside the first recess while the rock shaft is fitted in the second recess, and is disengageable from inside the first recess after the rock shaft is disengaged from inside the second recess.

2. A printer according to claim 1, wherein the rock shaft is slidingly movable along the slide opening portion.

3. A printer according to claim 1, further comprising an urging member provided between the platen frame and the rock shaft, for urging the rock shaft so as to slidingly move the rock shaft in a direction of being fitted into the second recess.

4. A printer according to claim 1, further comprising:
a base member for accommodating a sheet roll formed of a wound recording sheet to be fed between the recording head and the platen roller; and
a lid member openably and closably coupled to the base member, wherein:
the stationary frame is fixed to the base member; and
the platen frame is fixed to the lid member.

5. A printer according to claim 4, wherein the lid member comprises a manipulation lever for slidingly moving the rock shaft.
